(19) United States
(12) Patent Application Publication
(10) Pub. No.: US 2026/0035565 A1
(43) Pub. Date: Feb. 5, 2026

(54) COMPOSITION COMPRISING A POLYKETIDE PIGMENT

(71) Applicant: GIVAUDAN SA, VERNIER (CH)

(72) Inventor: Raja CHOUKET, Avignon (FR)

(21) Appl. No.: 19/099,203

(22) PCT Filed: Jul. 5, 2023
(86) PCT No.: PCT/EP2023/068578

§ 371 Date: Jan. 28, 2025

(30) Foreign Application Priority Data
Jul. 29, 2022 (GB) 2211084.5

(51) Int. Cl. C09B 67/14; A23L 5/47

(52) U.S. Cl. CPC C09B 67/0017; A23L 5/47

(57) ABSTRACT

The present invention provides a food colouring composition, in particular the invention provides a composition or colouring composition comprising at least one Polyketide pigment (i) and one or more of the following compounds (ii) a carotenoid (such as lycopene, bixin and/or norbixin), rosmarinic acid, a chlorogenic acid, rutin glucoside, (gamma) cyclodextrin and/or a tocopherol.

### TECHNICAL FIELD OF THE INVENTION

The present invention relates to a food colouring composition, in particular the invention provides a composition or colouring composition comprising (i) a Polyketide pigment and (ii) a carotenoid (such as lycopene), rosmarinic acid, a chlorogenic acid, rutin glucoside, cyclodextrin and/or a tocopherol, and the methods for producing said stabilized colouring compositions.

The invention also relates to the use of the food colouring composition as described herein in colouring a food product as well as to a food product comprising a food colouring composition as described herein.

### BACKGROUND OF THE INVENTION

Synthetic red dyes and particularly azo dyes like Allura Red AC (red dye 40) are commonly used for food colouring thanks to their attractive cost, vibrant red colour and excellent stability to light, heat, oxygen, pH and low microbiological contamination. However, these pigments have several side effects on health due to their toxicity.

This major limitation created a mounting pressure to find alternatives to these pigments, currently the most widespread red food colorants are anthocyanin (E163), red beetroot (E162) and carmine (E120). However, these pigments suffer from a series of drawbacks.

Anthocyanins are unstable at pH>3, which limits their use in dairy, bakery, and meat application where the pH ranges from 5.5 to 6.5.

Beetroot extract has poor stability due to several degradation reactions upon thermal stress such as hydrolysis, decarboxylation, oxidation and photo degradation of betacyanin molecule (Herbach, K. M., Stintzing, F. C. and Carle, R. (2006), Betalain Stability and Degradation—Structural and Chromatic Aspects. Journal of Food Science, 71: R41-R50).

Carmine is a bright red-pink colour pigment obtained from aluminium complex derived from carminic acid, this pigment is quite stable against light and heating which make it an attractive product in food industry. However, this pigment is extracted from an animal source (cochineal insect) which make it not vegan friendly product in addition this pigment is not fully natural since it's chemically modified (complexed with Aluminium).

Faced to these constraints manufacturers have been under pressure to find an alternative to satisfy natural, vegan, halal and kosher consumers, thus the search for novel food dyes based on natural compounds with high stability profile is nowadays very active.

As natural red solution, Monascus pigments have been used as a natural coloring agent and natural food additive in East Asia. This tasteless and odourless pigment is produced by various species of Monascus (M. purpureus i) via fermentation, is stable in a pH range of 2-10, and is known to be heat-stable, which make it an attractive sustainable product. Monascus purpureus is preserved in the general microbial centre of the China Committee for Culture Collection of Microorganisms, and the preservation number of the Monascus purpureus is CGMCC No. 11317. T

However, Monascus pigment has poor stability against light; several papers reported its sensitivity to sunlight and more specifically to UV irradiation. It has been reported that under light irradiation, monascus side chain is cleaved which generate superoxide anions, hydroxyl radicals, and other radicals. These radicals undergo further reaction with the double bonds in the pigment structure, which disturbs double bonds conjugation in monascus pigments, and thus causes a loss of chromatic properties and color fading.

Several attempts were conducted to improve its stability of Monascus and monascus like pigments, for example during the fermentation process.

CN201410118907 reported fermentation methods for preparing high-photostability monascus red pigment. Yang Yijin et al reported in Frontiers in Microbiology Journal (2021, volume 12, DOI=10.3389/fmicb.2021.678903) a stabilization using rutin and quercetin, however these molecules have poor solubility in aqueous conditions which limits their use to alcoholic beverages. Chinese patent CN102702780A discloses a method for preventing the color fading of monascus red pigment that consist in dissolve the monascus red pigment in 0.1 percent tryptophan, histidine, tyrosine or methionine solution.

Chinese patent CN103589189A discloses an application of retrograded starch in reducing the photofading of monascus red pigment, which is to add the retrograded starch into a monascus red pigment aqueous solution to make the monascus red pigment aqueous solution completely adsorbed in the retrograded starch to obtain a monascus red pigment product with the function of resisting light radiation.

Chinese patent CN101530190B discloses a monascus red pigment color fixative for food, which is composed of catechin 5-10%, vitamin C10-25%, glucose 30-40% and the balance of rutin.

Despite these numerous trials, the stabilization of Polyketide pigment (such as an azaphilone) was not successfully achieved and there is still a growing demand to identify an efficient solution to improve its stability.

### SUMMARY OF THE INVENTION

In the present invention we introduced new stabilization methods using natural water soluble or dispersible ingredients to enhance the photo stability of a Polyketide pigment such as an azaphilone.

The applicant has surprisingly and unexpectedly found that using carotenoids (such as lycopene) and/or other water-soluble compounds such as rosmarinic acid, chlorogenic acid, rutin glucoside and/or a tocopherol, results in a protection of the fading of the Polyketide pigments such as an azaphilones when exposed to light. Without being bound to any theory, the Polyketide pigment such as an azaphilone is protected thanks to the reduction of UV light absorption which is major actor leading to this photo damage

This improvement helps to stabilize Polyketide pigments such as an azaphilones for example in beverages and confectionary offering thus a vibrant stable red colour. With the solutions described in the present application, we can benefit from its clean and non-GMO labelling, good nutritional values and neutral taste without off notes in the final application.

Therefore, the invention provides a method for stabilizing the colour of a Polyketide pigment comprising contacting (i) a Polyketide pigment with (ii) a carotenoid (such as lycopene), rosmarinic acid, rutin glucoside, cyclodextrin and/or a tocopherol, wherein the resulting Polyketide pigment is light stable.

In another aspect, the invention provides a stabilized pigment obtained according to the stabilizing method of the invention.

In another aspect, the invention provides a colouring composition comprising a stabilized pigment and additionally a suitable carrier or excipient.

In another aspect, the invention provides a foodstuff, a pharmaceutical, a nutraceutical, a perfume or a cosmetic product comprising a stabilized pigment according to the invention or a colouring composition according to the invention, optionally that was exposed to light.

In another aspect, the invention provides a method for producing a foodstuff, a pharmaceutical, a nutraceutical, a perfume or a cosmetic product comprising the steps of incorporating a stabilized pigment according to the invention or a colouring composition according to the invention to a foodstuff, a pharmaceutical, a nutraceutical, a perfume or a cosmetic product.

In another aspect, the invention provides a method for producing a foodstuff, a pharmaceutical, a nutraceutical, a perfume or a cosmetic product comprising the steps of incorporating components (i) and component (ii) as defined in any one of the previous claims, wherein component (i) is added directly to the product and consequently product (ii) is also added to the product or wherein component (ii) is added directly to the product and consequently product (i) is also added to the product, especially when the product is a liquid or a semisolid.

### BRIEF DESCRIPTION OF THE DRAWINGS

FIG. 1. Light stability measurements of solution 1A, 1B and 1C. Pigment retention.

FIG. 2. Light stability measurements of solution 1A, 1B and 1C. dE2000.

FIG. 3. Light stability measurements of solution 2A, 2B, 2C, 2D, 2E, 2F. Pigment retention

FIG. 4. dE2000 measurements of solution 3A, 3B, 3C and 3D.

FIG. 5. Pigment retention over time. Samples 3A, 3B, 3C and 3D.

FIG. 6. Pigment retention over time. Samples 4A, 4B, 4C and 4D.

FIG. 7. dE2000 measurements of samples 4A, 4B, 4C and 4D.

FIG. 8. dE2000 measurements of samples 5A, 5B, 5C, 5D and 5E.

FIG. 9. Pigment retention over time. Samples 5A, 5B, 5C, 5D and 5E.

FIG. 10. Colour variation upon 8 h light irradiation is sugar paste of samples 7A, 7B, 7C and 7D.

FIG. 11. dE2000 measurements of samples 6A, 6B, 6C and 6D.

### DEFINITIONS

As used herein, the term “pigment” refers to any substance that imparts colour by absorbing or scattering light at different wavelengths.

The term “colouring composition” refers to any pigment formulated with one or more other products such as carriers, etc.

The term “colour” refers to the colour properties such as hue, chroma, purity, saturation, intensity, vividness, value, lightness, brightness and darkness, and colour model system parameters used to describe these properties, such as Commission Internationale de l'Eclairage CIE 1976 CIELAB colour space L*a*b* values.

The term “hue” refers to the colour property that gives a colour its name, for example, red, blue and brown.

### DETAILED DESCRIPTION

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature. For instance, a CGA may be interpreted as one chlorogenic acid or as more than one chlorogenic acids.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

### Method for Stabilizing a Polyketide Pigment.

Surprisingly, it was found that by combining a Polyketide pigment (such as an azaphilone), more specifically a monascus pigment with one or more of a carotenoid (such as lycopene), rosmarinic acid, a chlorogenic acid, rutin glucoside and/or a tocopherol, results in a stabilized Polyketide pigment (such as an azaphilone), more specifically a monascus pigment, with an increased stability to light exposure if compared to the Polyketide pigment (such as an azaphilone), more specifically a monascus pigment alone.

Therefore, the invention provides a method for stabilizing the colour of a Polyketide pigment (such as an azaphilone) comprising contacting (i) a Polyketide pigment with (ii) a carotenoid (such as lycopene), rosmarinic acid, a chlorogenic acid, rutin glucoside, cyclodextrin and/or a tocopherol, wherein the resulting Polyketide pigment (such as an azaphilone) is light stable.

The invention also provides a method for producing a light stable Polyketide pigment (such as an azaphilone) that comprises the steps of: a) contacting (i) a Polyketide pigment with (ii) a carotenoid (such as lycopene), rosmarinic acid, a chlorogenic acid, rutin glucoside, cyclodextrin and/or a tocopherol, and optionally b) mixing (i) and (ii).

Thus it is also provided a “stabilized Polyketide pigment” or “light stable Polyketide pigment” obtained using the methods of the invention. Both terms “stabilized Polyketide pigment” or “light stable Polyketide pigment” are interchangeable in the present description.

Without wishing to be bound by theory, it is believed that the Polyketide pigment (such as an azaphilone) and the lycopene forms a complex that provide stabilized colouring compositions with a colour such as a red, orange or yellow that is stable to light exposure (i.e the colour hue does not fade when exposed to light).

As used herein, “contacting” may correspond to the physical interaction of Polyketide pigment (such as an azaphilone) with a compound (ii) a carotenoid (such as lycopene), rosmarinic acid, a chlorogenic acid, rutin glucoside, (gamma) cyclodextrin and/or a tocopherol, as described herein, which promotes the stabilization (light stabilization) of the Polyketide pigment.

“Contacting with a compound (ii)” may correspond to contacting with a single compound (such a lycopene) or with a mixture of compounds (for example a lycopene and a CHA(s)).

Optionally, the methods of the invention may comprise a further step of mixing (i) and (ii) to obtain a homogenous mixture.

### Polyketide Pigments

Polyketides that form part of the present invention include, but is not limited to azaphilones, anthraquinones, hydroxyanthraquinones and naphthaquinones.

For the avoidance of doubt, “a Polyketides pigment” or “the Polyketide pigment” in the present invention are defined as one or more Polyketide pigments, that is, it may refer to only one type of polyketide (such as a purified azaphilone) or it may refer to a combination of several pigments (for example a mixture of atrorosin-type azaphilone pigments that are obtained from Talaromyces atroroseus as disclosed in EP3622081 A1).

In preferred embodiments, mycotoxins are excluded. In a preferred embodiment, the Polyketide pigment is essentially free of mycotoxins such as Citrinin and its derivates, spiciferinone, cochliospicin A, Austdiol and it derivates.

Azaphilones that form part of the present invention may be any of those compounds that can be obtained from fungal genera, including those obtainable from Aspergillus genus, Chaetomium genus, Hypoxylon genus, Monascus genus, Muycopron genus, Penicillium genus, Phomopsis genus, Pleosporales genus, Talaromyces genus, Pestalotiopsis genus, Phomopsis genus, Emericella genus, Epicoccum genus, Hypoxylon genus. (Jin-Ming Gao et al. Azaphilones: Chemistry and Biology Chem. Rev. 2013, 113, 7, 4755-4811).

Particular classes of azaphilones include but are not limited to nitrogenated azaphilones, austdiols, spiciferinone and derivatives, deflectins, helotialins, bulgarialactones, spiro-azaphilones, O-substituted azaphilones (particularly O-containing monascus pigments), lactone azaphilones, hydrogenated azaphilones, chaetoviridins and chaetomugilins, sequoiatones, tricoflectin and sassafrin azaphilones, pulvilloric acid-type azaphilones, sclerotiorins, multiformins and cohaerins, ascochitine, chrysodin-type azaphilones, hydrogenated spiro azaphilones, chlorofusins and atrorosins.

Still more particularly, azaphilone pigments include those atrorosin-type azaphilone pigments disclosed in EP3622081 A1 and in Rasmussen K. B et al. (“Talaromyces atroroseus-Genome sequencing, Monascus pigments and azaphilone gene cluster evolution” 2015. Retrieved from internet: https://orbit.dtu.dk/en/publications/italaromyces-atroroseusi-genome-sequencing-monascus-pigments-and-), which are incorporated here by reference.

This atrorosin-type azaphilone pigments described in EP3622081 A1 and in Rasmussen K. B et al. are “Monascus” like pigments are biosynthesided by Talaromyces atroroseus and are incorporated here by reference. Those monascus like pigments have similar azaphilone scaffolds as the orange Monascus pigment PP-O, with a carboxylic acid group C—I but are unique by their incorporation of amino acids into the isochromene system. Atrorosins described in EP3622081 A1 and in Rasmussen K. B et al. are mostly red pigments and their production is mycotoxin free.

The pigments described in EP3622081 A1 and in Rasmussen K. B et al. are biosynthesided by Talaromyces atroroseus using organic (such as one or more aminoacids, peptides, amino sugar and/or primary amines) and/or inorganic compounds as nitrogen sources.

Azaphilone pigments further include those azaphilone pigments set out in Jin-Ming Gao et al. (Azaphilones: Chemistry and Biology Chem. Rev. 2013, 113, 7, 4755-4811) including but not limited to monascusone B (that was isolated from a yellow mutant of Monascus kaoliang grown on rice), Monascuspiloin and monascusazaphilol (metabolites of two different strains of Monascus pilosus) Sequoiamonascin C (isolated from a redwood endophyte A. parasiticus), monarubrin and rubropunctin (identified from the Monascus pigments and from the broth of Monascus ruber), monaphilones A and B (isolated from the red mold rice fermented by mutant strain M. purpureus NTU 568), biscogniazaphilones A and B (obtained from the endophytic fungus Biscogniauxia formosana BCRC 33718).

Azaphilone pigments include the monascus-type azaphilones including, but not limited to the yellow pigments monascin (C21H26O5) and ankaflavin (C23H30O5), the orange pigments monascorubrin (C23H26O5) and rubropunctatin (C21H22O5), and the red pigments monascorubramine (C23H27NO4) and rubropuntamine (C21H23NO4) (Jin-Ming Gao et al.

Azaphilones: Chemistry and Biology Chem. Rev. 2013, 113, 7, 4755-4811), all their derivatives and monascorubraminic acid (compound of formula (I)).

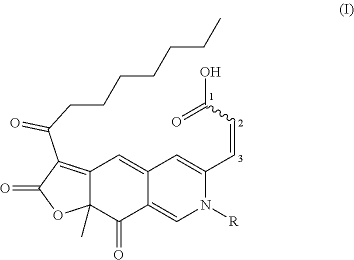

wherein in the monascorubramine (C23H27NO4), rubropunctamine (C21H23NO4) and monascorubraminic acid the
N—R is selected from the group consisting of an amino acid, a peptide, an amino sugar and a primary amine,
and wherein the wavy bond is indicating an unspecified configuration of the adjacent double bond between carbon 2 and 3.

The double bond adjacent to the carboxylic group of the compound of formula (I) can have either E- or Z-configuration, or the compound is present as a mixture.

For example, the amino acid is selected from the group consisting of alanine, arginine, asparagine, aspartate (aspartic acid), cysteine, glutamate (glutamic acid), glutamine, glycine, histidine, isoleucine, leucine, lysine, methionine, phenylalanine, serine, threonine, tyrosine, valine and ornithine. (The amino acid can be in L or in D configuration, or a mixture of them.)

For example, the amino sugar is selected from the group consisting of glucosamine and galactosamine.

For example, the primary amine is selected from the group consisting of anthranilic acid, aniline, p-phenylenediamine, and ethanolamine.

As “derivatives” in this text are referred to the basic structure (for instance of the above mentioned monascus-type azaphilones) that have different amino acid chains in position 10. For example, it was reported that culturing of both M. ruber and M. purpureus A on a chemically defined medium using glutamic acid as a nitrogen source yielded two pigments, N-glutarylrubropunctamine and N-glutarylmonascorubramine, which were linked to glutamic acid by amino groups. Similarly, the fungus M. ruber in a submerged culture produced two water-soluble red pigments, N-glucosylrubropunctamine and N-glucosylmonascorubramine.

N-containing Monascus pigments commonly consist of an isoquinoline skeleton with an n-octanoyl or an n-hexanoyl side chain, a 1-propenyl chain, and a γ-lactone ring. Most of the pigments are various amino acid derivatives of monascorubrin and rubropunctatin (rubropunctamine and monascorubramine)

Depending on the supplementation to the fermentation medium, different monascus like pigments may be obtained (for example Alanine or aspartate derivatives of monascorubrin and rubropunctatin, Monascus pigment threonine derivatives, arginine derivatives, cultivation of M. purpureus resting cells with glycine has been found to give the dark red substances, unnatural amino acids (for example, the derivatives containing penicillamine (H-Pen), cyclohexylalanine (H-Cha), butylglycine (L-t-Bg), and norleucine (H-Nle,)

Also, cavernamine pigment as the ones described in WO202094830 are included herein.

The aforementioned pigments can be obtained by extraction extracted from a natural source, or be otherwise derived from a natural source, such as plants, fungi, bacteria or algae.

The pigments may be native, i.e. extracted unmodified from their natural state, or taken from their natural state and purified or even chemically modified.

They may be provided as mixtures, or they may be prepared or isolated singly.

If the compounds are to be prepared singly, they may be extracted from a natural source and purified, or they may be prepared via chemical synthesis or by fermentation.

### Carotenoids

Carotenoids or tetraterpenoids, are yellow, orange, and red organic pigments that are produced by plants and algae, as well as several bacteria, and fungi.

In certain embodiments, the carotenoid may be selected from (i) pure hydrocarbons called carotenes, including but not limited to compounds such as β-carotene, α-carotene, γ-carotene or lycopene, (ii) molecules called xanthophylls, which contain oxygen in various forms (hydroxyl groups, epoxy groups, etc.), including but not limited to astaxanthin, zeaxanthin, capsanthin, cantaxanthin, lutein, etc, and (iii) molecules called apocarotenoid such as bixin and norbixin and any mixture thereof.

In a particular case, the carotenoid composition of the invention can be mixed with an oil forming an oily solution of the carotenoid composition so that the final carotenoid content is equal or superior to 30% w/w. In a preferred embodiment, the final carotenoid content in the oily solution is at least 31%, at least 32%, at least 33%, at least 34%, at least 35%, at least 36%, at least 37%, at least 38%, at least 39%, at least 40%, at least 45%, at least 50%, at least 55%, at least 60%, at least 65%, at least 70% or at least 75% (w/w).

This oily solution of carotenoid could be optionally emulsified as oil-in-water emulsion containing between 1 and 20% of oil (preferably olive oil, sunflower oil, oil comprising medium chain triglycerides, or mix of them). In a particular embodiment, the final concentration of carotenoids in the oil-in-water emulsion is between 0.1 to 10%, more preferably 0.5 to 8%.

In a preferred embodiment, the carotenoid is Lycopene.

Lycopene (CAS number is 502-65-8) is a symmetrical tetraterpene, i.e. assembled from eight isoprene units. It is a member of the carotenoid family of compounds, and because it consists entirely of carbon and hydrogen, is also classified as a carotene. Lycopene (C40H56) is an intermediate in the biosynthetic pathway of β-carotene and the xanthophylls. It has a molecular weight of 536.85 and the following molecular formula:

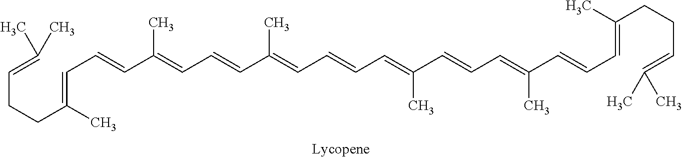 [SMILES: CC(C)=CCC/C(C)=C/C=C/C(C)=C/C=C/C(C)=C/C=C/C=C(C)/C=C/C=C(C)/C=C/C=C(\C)CCC=C(C)C]

Although lycopene exists in different forms, having different colors and intensities, the term “lycopene” is used in all cases to indicate the chemical entity. It should be noted however, that crystalline lycopene has an intense red color, and differs from dissolved or dispersed or solubilized lycopene, which has a yellow-orange color. Furthermore, lycopene naturally occurring in fruit is found in chromoplasts in crystalline form, and therefore is capable of retaining its red color, as in the tomato.

As stated, the intense red color of lycopene is due to its crystalline form, and is influenced by its particle size distribution. Lycopene loses its staining power in the red range when the crystals dissolve, which occurs readily in a variety of organic solvents, e.g., oils. When lycopene oleoresin is solubilized in aqueous solutions, it assumes a yellowish to orange color, depending on concentration.

In certain embodiments, the lycopene used in the present invention is in its crystalline form.

In certain embodiments, the lycopene used in the present invention may be obtained or obtainable from a natural source or may have a synthetic origin. In certain embodiments, the lycopene may be obtained or obtainable from a plant, a photosynthetic bacterium, fungi and/or algae.

As will be appreciated by the person skilled in the art, as used herein the term “obtainable from” means that the lycopene may be obtained from a plant/algae/animal/prokaryote directly or may be isolated from the plant, a photosynthetic bacterium, fungi and/or algae, or may be obtained from an alternative source, for example by chemical synthesis or enzymatic production. Whereas the term “obtained” as used herein, means that the extract is directly derived from the plant, a photosynthetic bacterium, fungi and/or algae source.

In certain embodiments, the Lycopene may be obtained or obtainable from plant products such as: tomato, carrot, peppers, vegetable oils, autumn olive, gac, watermelon, pink grapefruit, pink guava, papaya, seabuckthorn, wolfberry (goji, a berry relative of tomato), rosehip, and any mixture thereof.

The lycopene used in the present invention may be produce form a plant product using any kind of process such as the ones described in patent WO 97/48287, that describes a method for the preparation of lycopene-rich oleoresins from tomatoes by pressing the tomatoes until the pulp is obtained, extraction of lycopene from the pulp with organic solvents and subsequent elimination of the solvent by evaporation, giving rise to an oleoresin with a lycopene content in the range 2-10%. Similar methods of obtaining oleoresins rich in carotenoids in general and lycopene in particular from plants and oils are described in various patents, such as in U.S. Pat. No. 5,245,095 and EP 580745, by precipitation with calcium salts, in U.S. Pat. No. 5,019,668, using a method of transesterification with oils followed by distillation, in WO 95/16363, which describes the fractionation of the tomato into various fractions that include an oleoresin rich in carotenoids, and in PCT WO 90/08584, which describes the extraction of lycopene by using fluids in a supercritical state, although the extract obtained is a mixture of various carotenoids and the extraction yields are very low owing to their low solubility. All those methods are incorporated herein by reference.

In certain embodiments, the lycopene is in a form of a natural oleoresin, such as a paprika oleoresin, a tomato oleoresin, etc.

Lycopene preparations of biological origin may be also obtained by fermentation of mucoral fungi of the genera Phycomyces, Blakeslea and Choanephora [GB 1008469, U.S. Pat. Nos. 3,097,146, 3,369,974, JP 73016189, JP 73016190, RU 2102416, WO 00/77234], which are incorporated herein by reference Lycopene can also be obtained from fungus B. trispora, as described in WO03/056028 A1 which is incorporated herein by reference.

Certain carotenoid-rich micro-algae of the Dunaliella type are another important source of lycopene. There are various methods of extracting carotenoids, and lycopene in particular, from these organisms, as is reflected in patents U.S. Pat. Nos. 5,378,369, 4,713,398 and 4,680,314, by extraction with organic solvents (chlorocarbons, hydrocarbons, etc.) or edible oils (DE 4342798). A different process is described in PCT WO 98/08584, where a lycopene extract is obtained using CO2 in a supercritical state, although the extract thus obtained is of low purity with respect to lycopene. All those methods are incorporated herein by reference.

The oleoresins comprising lycopene with different purities may be used in the present invention. In certain embodiments, the oleoresin may comprise at least 2% of lycopene, such as at least 5%, such as at least 10%, at least 50% or at least 99% of lycopene.

In certain embodiments, the lycopene is a Tomato oleoresin containing about 40%-100% lycopene in the form of a free-flowing powder.

In certain embodiments, the lycopene is a trans lycopene, a cis lycopene or a mixture thereof.

In certain embodiments, the lycopene is in form of crystals characterized by having a crystal purity above 10%, such as above 20%, such as above 50%, such as above 95%. In certain embodiments the crystals have a content of cis lycopene below 3%, and content of other carotenoids below 3%.

In certain embodiments, the lycopene crystals may be mixed with other carotenoids as described herein.

In certain embodiments, the lycopene is prepared according to the patent application with number U.S. Pat. No. 5,965,183A which is incorporated herein by reference. This patent application describes a process for the preparation of stable lycopene concentrates, that comprises size-reducing lycopene crystals in a food-compatible liquid medium which essentially does not dissolve lycopene. This patent application describes process for the preparation of a crystalline lycopene composition, which process comprises treating a lycopene-containing oleoresin with a solvent or solvent mixture which dissolves the lipid phase of the oleoresin (such as acetone/ethyl acetate solvent mixture) and which does not substantially dissolve lycopene, to remove therefrom a major part of the oleoresin lipids

In certain embodiments, it is preferred that the lycopene crystals be ground to an average particle size of below about 5 μm, such as average particle size of about 1-3 μm.

In certain embodiments, the lycopene is dissolved in a food-compatible liquid selected from the group consisting of glycerol, propylene glycol and ethanol, or their mixtures, or mixtures thereof with other food-compatible liquids. In certain embodiments, the lycopene solution additionally comprises lecithin and/or sucrose ester.

In certain embodiments, the Lycopene was extracted from tomato using Ethyl acetate and ethanol, and after purification and concentration the final product is formulated on glycerol, lecithin, sucrose ester and water.

In another preferred embodiment, the carotenoid is bixin and/or norbixin.

In certain embodiments, the Bixin or norbixin may be obtained or obtainable from plant products such as the seeds of Achiote trees (Bixa Orellana). The oil of the seeds of Achiote trees is commonly known as annatto or annatto colorant. Annatto in the European Union, it is identified by the E number E160b.

In certain embodiments, annatto colorant obtained or obtainable from the seeds of Achiote trees comprising Bixin and/or norbixin is used in the present invention.

In other embodiments, Bixin or norbixin are from synthetic origin.

In other embodiments, the carotenoid is a mixture of lycopene, bixin and/or norbixin.

Rosmarinic acid may be of natural or synthetic origin. In certain embodiments, the rosmarinic acid is a natural product for example in the form of an Lamiaceae extract.

As used herein, the term “Lamiaceae extract” may refer to an extract from a plant of the Lamiaceae family, including but not limited to rosemary, sage, oregano, thyme, mints, and the following genera: Melissa (Melissa officinalis or Lemon balm), Salvia (such as Salvia Apiana and Salvia officinalis), Rosmarinus (such as Rosmarinus officinalis), Lepechinia, Oreganum, Thymus, Hyssopus and any mixtures thereof.

The Lamiaceae material used for extracting the Lamiaceae extract rich in rosemarinic acid can be any part of the plant such as leaves, roots, flowers, stems, etc. In a preferred embodiment, the part of the plant are the leaves and/or the stems.

The Lamiaceae material may be processed before extraction, for example it can be washed, dried, milled or grounded, etc.

The Lamiaceae extract (such as a rosemary and/or Melissa extract) may be obtained or obtainable by the extraction of the aerial parts of a Lamiaceae extract (such as a rosemary and/or Melissa extract) with a solvent followed by optional purification depending on the concentration of the rosmarinic acid required in the final extract.

Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In certain embodiments, the Lamiaceae extract (such as a rosemary and/or Melissa extract) comprises at least 1% w/w of rosmarinic acid, such as at least 3%. In certain embodiments the Lamiaceae extract (such as a rosemary and/or Melissa extract) comprises from 1% to 99% rosmarinic acid.

### Chlorogenic Acid (CGAs)

Hereinafter the term “CGA(s)” or “chlorogenic acid(s)” will mean one or more chlorogenic acid(s) and their derivatives including, but not limited to: neo-chlorogenic acid (neo-CGA; 5-O-caffeoylquinic acid or 5-CQA), crypto-chlorogenic acid (cryp-to-CGA; 4-0-caffeoylquinic acid or 4-CQA), n-chlorogenic acid (n-CGA; 3-O-caffeoyl quinic acid or 3-CQA), iso-chlorogenic acid A (iso-CGA A; 3,5-dicaffeoylquinic acid) iso-chlorogenic acid B (iso-CGA B; 3,4-dicaffeoylquinic acid), iso-chlorogenic acid C (iso-CGA C; 4,5-dicaffeoylquinic acid), other chlorogenic acids and iso-chlorogenic acids known to art, and combinations thereof.

The CGA(s) may be of natural origin or may be or synthetic origin.

CGA(s) may be extracted from a variety of natural sources. Thus in a preferred embodiment, the chlorogenic acid(s) is extracted from a biological material that contains chlorogenic ac-id(s), such as plants, animals or prokaryote.

The CGA(s) containing biological material is preferably plant biological material. The plant biological material may be obtained from or obtainable from plant roots and/or plant aerial parts, such as the leaves, flowers, stems, barks, fruits and/or seeds, their tissues (such as the rind of the fruit) or mixtures thereof. For example, the plant biological material may be the leaves of the plant.

As will be appreciated by the person skilled in the art, as used herein the term “obtainable from” means that the plant and/or animal and/or prokaryotic biological material may be obtained from a plant/algae/animal/prokaryote directly or may be isolated from the plant/algae/animal/prokaryote, or may be obtained from an alternative source, for example by chemical synthesis or enzymatic production. Whereas the term “obtained” as used herein, means that the extract is directly derived from the plant/algae/animal/prokaryote source.

Non-limitative examples of CGA(s) containing plant biological material are green coffee beans from any species of the genus coffea such as Coffea arabica (Arabica), Coffea canephora (Robusta), Coffea liberica (Liberica), etc; leaves of Ilex paraguariensis, pome fruits (e.g., apples and pears), stone fruits (e.g., cherries and plums), berry fruits, citrus fruits, brassica vegetables (e.g., kale, cabbage and brussel sprouts), solanaceae (e.g., potato tubers, tomatoes, and aubergines), asteraceae (e.g., chicoryroot and artichokes), and a variety of other miscellaneous vegetables. It may also be found in cereal grains (e.g., oats, barley, rye, rice, corn and wheat). The amount and different types of chlorogenic acid that are present vary depending upon the source. Chlorogenic acid may be extracted from one or more botanical sources, and/or synthetic chlorogenic acid may be used.

In a preferred embodiment, the CGA(s) is obtained or is obtainable from Arabica, Robusta and/or Liberica green coffee beans and is defeneid herein as “green coffee extact”.

The CGA(s) of natural origin can be present in the composition of the invention as purified CGA(s) or as natural extracts obtained or obtainable from Arabica, Robusta and/or Liberica green coffee beans mentioned before.

Different extractions methods know in the art may be used to obtain the CGAs. For example, solvents that may be use for extraction include, but are not limited to: water, alcohols (like ethanol), acetone and any mixture thereof.

### Rutin Glucoside.

Polyglycosylated rutin that form part of the present invention has the following formula:

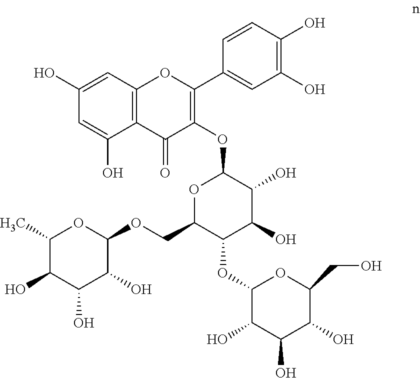 [SMILES: C[C@@H]1O[C@@H](OC[C@H]2O[C@@H](Oc3c(-c4ccc(O)c(O)c4)oc4cc(O)cc(O)c4c3=O)[C@H](O)[C@@H](O)[C@@H]2O[C@@H]2O[C@@H](CO)[C@H](O)[C@@H](O)[C@@H]2O)[C@H](O)[C@H](O)[C@H]1O]

in which over 50% molarity of the glycosylated rutin has n greater than 2.

The glycosylation of rutin, a polyphenolic flavonoid, is well known in the art, for example, from Journal of Microbiology and Biotechnology Volume 26 Issue 11, pp. 1845-1854 (2016) and U.S. Pat. No. 5,145,781. Glycosylated rutin is known for its water solubility, superior to that of rutin, thus allowing rutin to be made readily available.

The glycosylation of rutin takes place on the fourth carbon of the glucose unit. This process invariably results in a spread of values of n, ranging from 1 upwards. In this disclosure, glycosylated rutins where n>2 comprise the majority of glycosylated rutins, higher than 50%, more particularly higher than 60% molarity. In a particular embodiment, the average value of n is from 2-11, particularly at least 3, more particularly from 3-4.

### Tocopherol

In the present disclosure, tocopherol (or Vitamine E) may include four tocopherols and four tocotrienols. In certain embodiments, the tocopherol is selected from Alpha, beta, gamma, and delta tocopherol or mixtures thereof. As a food additive, tocopherol is labelled with the E numbers: E306 (tocopherol), E307 (α-tocopherol), E308 (γ-tocopherol), and E309 (δ-tocopherol).

In certain embodiments, the tocopherol used in the present invention may be obtained or obtainable from a natural source. In certain embodiments may have a synthetic origin. In certain embodiments, the tocopherol may be obtained or obtainable from a plant, a photosynthetic bacterium, fungi and/or algae.

In certain embodiments the tocopherol may be obtained or obtainable from crude vegetable oils such as soy bean, sunflower, canola, rapeseed, cottonseed, safflower, corn, palm, palm kernel, and rice bran oil.

Water-soluble vitamin E (α-tocopherol, αT), such as its esters with acetate (αTA), succinate (αTS), or phosphate (αTP), have increased solubility in water and stability against reaction with free radicals.

In certain embodiments, the tocopherol is a Water dispersible tocopherol.

### Gamma Cyclodextrin:

Cyclodextrins are a family of cyclic oligosaccharides, consisting of a macrocyclic ring of glucose subunits joined by α-1,4 glycosidic bonds. Cyclodextrins are produced from starch by enzymatic conversion. In the present invention, Alfa, beta and/or gamma cyclodextrin may be used.

In a preferred embodiment, gamma cyclodextrin is used. Gamma cyclodextrin has a Cas number 17465-86-0. Gamma-cyclodextrin is a cycloamylose composed of eight alpha-(1->4) linked D-glucopyranose units. The Molecular Weight is1297.1.

In the methods of the invention, a Polyketide pigment (such as a the azaphilones mentioned herein) is mixed with a second product (ii) selected from the list of a carotenoid (such as lycopene), rosmarinic acid, a chlorogenic acid, rutin glucoside, cyclodextrin and/or a tocopherol.

In a preferred embodiment, the azaphilone is an atrorosin-type azaphilone pigment as the ones disclosed in EP3622081 A1 or in Rasmussen K. B et al.

In another preferred embodiment, the azaphilone is a pigment described in Jin-Ming Gao et al.

In another preferred embodiment, the azaphilone is a monascus pigment, such as one or more of monascin (C21H26O5), ankaflavin (C23H30O5), monascorubrin (C23H26O5), rubropunctatin, monascorubramine (C23H27NO4) and/or rubropuntamine (C21H23NO4).

In another preferred embodiment, the azaphilone is obtained or is obtainable from Aspergillus genus, Chaetomium genus, Hypoxylon genus, Monascus genus, Muycopron genus, Penicillium genus, Phomopsis genus, Pleosporales genus, Talaromyces genus (such as Talaromyces atroroseus), Pestalotiopsis genus, Phomopsis genus, Emericella genus, Epicoccum genus, Hypoxylon genus.

The Polyketide pigment (such as the azaphilones mentioned herein) may be present in solid form (such as powder) or in a liquid solution. Thus, in certain embodiments, the Polyketide pigment (such as an azaphilone) is an aqueous solution. In certain embodiments, the aqueous solution may comprise at least 50% water, such as at least 70% water, such as at least 90% water.

The product(s) (ii) may be present in form of a solid form (such as a powder) or in a liquid solution. “Liquid solution” herein include without limitation any solution, emulsion or dispersion of the components of the mix in a liquid solvent. The liquid solvent may be water, glycerol or other liquid suitable to dissolve or disperse the components of the mix (Polyketide pigment (such as the azaphilones mentioned herein) and the component (ii) or any mixture of solvents. In certain embodiments, the aqueous solution may comprise at least 50% water, such as at least 70% water, such as at least 90% water.

In certain embodiments, the Polyketide pigment (such as an azaphilone) is presented in an aqueous solution.

In certain embodiments, both products, Polyketide pigment and the product (ii), may be in form or a powder and mixed in the form of a powder. Optionally, the mixed powder obtained is then added to a suitable solvent, like water, and optionally mixed until a homogenous solution is obtained.

In other embodiments, the Polyketide pigment is in form of a powder that is added to the second component (ii) that is in liquid form.

In other embodiments, the Polyketide pigment is the form of a liquid and the component (ii) is in form of a powder that is added to the liquid Polyketide pigment.

Optionally, the Polyketide pigment and the component (ii) may be optionally further mixed until a homogenous mixture is obtained. The mix of both components may be done for at least 5 minutes, such as at least 10 minutes, such as at least 30 minutes, such as at least 1 hour. Any method known in the art to mix the components may be use in this invention.

In preferred embodiments, lycopene is used. Lycopene, as mentioned before, forms crystals that are normally provided as an emulsion in solvents where lycopene is not soluble such as glycerol, water and mixture of them. Thus, in certain embodiments, a suspension of lycopene crystals is used in the method of the invention.

In certain embodiments, the lycopene is in the form of an emulsion.

In Certain Embodiments, the Carotenoid is Selected from Lycopene, Bixin and/or Norbixin.

In certain embodiments the method of the invention additionally comprises a further step of filtration to remove the non-soluble fractions.

In certain embodiments the method of the invention, additionally comprises a step of concentrating the stabilized Polyketide pigment obtained using the methods described herein.

In certain embodiments, the methods of the invention additionally comprise a step of drying, such as spray drying.

The resulting stabilized Polyketide pigment (such as an azaphilone) obtained using the methods described herein comprises as already mentioned a Polyketide pigment (such as an azaphilone) and one or more of the compounds selected from carotenoids (such as lycopene, bixin and/or norbixin), rosmarinic acid, a chlorogenic acid, rutin glucoside or tocopherol and has an improved stability to light exposure.

As the person in the art recognizes, the carotenoid(s) such as lycopene, bixin and/or norbixin may be used alone to stabilize the Polyketide pigment (such as an azaphilone) or it may be used in combination with one or more of rosmarinic acid, chlorogenic acid(s), rutin glucoside, cyclodextrin or tocopherol. If more than one component is used to stabilize the Polyketide pigment (such as an azaphilone), they can be used together or may be added sequentially to the Polyketide pigment.

As mentioned before, the rosmarinic acid, rutin glucoside, cyclodextrin and/or tocopherol may be provided in a solid or in a liquid form. Thus, in certain embodiments, they are provided in a solid form, such as a powder that may be added directly to the Polyketide pigment (such as an azaphilone) solution. In case they are provided as a solution, both solutions (Polyketide pigment (such as an azaphilone) and rosmarinic acid etc) can be contacted and optionally mixed (step b).

The ratio between the Polyketide pigment (such as an azaphilone) and the compound (ii) may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

The ratio between the Polyketide pigment (such as an azaphilone) and the compound (ii) may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and the compound (ii) may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the Polyketide pigment (such as an azaphilone) is contacted with a carotenoid, such as a lycopene, bixin and/or norbixin in a weight ratio of 99:1 to 75:25.

In certain embodiments, the ratio between the Polyketide pigment (such as an azaphilone) and a carotenoid, such as lycopene, bixin and/or norbixin may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and a carotenoid, such as lycopene, bixin and/or norbixin may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and a carotenoid, such as lycopene, bixin and/or norbixin may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with the rosmarinic acid in a weight ratio of 75:25. In a preferred embodiment, the rosmarinic acid is obtained of obtainable from a Lamiaceae such as rosemary or lemon balm. In a preferred embodiment a Lamiaceae extract such as a rosemary and/or lemon balm extract comprising rosmarinic acid is used. As the person skilled in the art knows, the natural extracts may have variable concentrations of rosmarinic acid, the Lamiaceae extract will be used in a concentration so as to provide the ratios of Polyketide pigment (such as an azaphilone) and rosmarinic acid defied herein.

In certain embodiments, the ratio between the Polyketide pigment (such as an azaphilone) and rosmarinic acid may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90. In a preferred embodiment, the Polyketide pigment (such as an azaphilone) is contacted with the rosmarinic acid in a weight ratio of 75:25.

In certain embodiments, the ratio of ratio between the Polyketide pigment (such as an azaphilone) and rosmarinic acid may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and rosmarinic acid may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with CGA(s) in a weight ratio of 95:5 to 80:20. In a preferred embodiment, the CGA(s) are provided by a green coffee extract that is obtained of obtainable from green coffee beans from one or more of the species of the genus coffea such as Coffea arabica (Arabica), Coffea canephora (Robusta), Coffea liberica (Liberica). In a preferred embodiment the CGA(s) are provided by a natural extract comprising CGA(s). As the person skilled in the art recognises, the natural extracts comprising CGA(s), such as a green coffee extract, may have variable concentrations of CGA(s), therefore the natural extract comprising CGA(s), such as a green coffee extract, will be used in the present invention in a concentration so as to provide the ratios of Polyketide pigment (such as an azaphilone) and CGA(s) defied herein.

In certain embodiments, the ratio between the Polyketide pigment (such as an azaphilone) and CGA(s) may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and CGA(s) may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and CGA(s) may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with rutin glucoside in a weight ratio of 80:20 to 50:50, such as 75:25.

In certain embodiments, the ratio between the Polyketide pigment (such as an azaphilone) and rutin glucoside may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and rutin glucoside may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and rutin glucoside may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with cyclodextrin, specially gamma cyclodextrin in a weight ratio of 80:20 to 50:50.

In certain embodiments, the ratio between the Polyketide pigment (such as an azaphilone) and with cyclodextrin, specially gamma cyclodextrin may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and with cyclodextrin, specially gamma cyclodextrin may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and with cyclodextrin, specially gamma cyclodextrin may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with tocopherol, especially soluble or dispersible tocophenol, in a weight ratio of 99:1 to 90:10.

In certain embodiments, the ratio between the Polyketide pigment (such as an azaphilone) and tocopherol (specially soluble tocophenol) may be equal to or lower than 99:1 or about 99:1. In some embodiments, the ratio is equal to or lower than 95:5 or about 95:5. In some embodiments, the ratio is equal to or lower than 90:10 or about 90:10. In some embodiments, the ratio is equal to or lower than 85:15 or about 85:15. In some embodiments, the ratio is equal to or lower than 80:20 or about 80:20. In some embodiments, the ratio is equal to or lower than 70:30 or about 70:30. In some embodiments, the ratio is equal to or lower than 60:40 or about 60:40. In some embodiments, the ratio is equal to or lower than 50:50 or about 50:50. In some embodiments, the ratio is equal to or lower than 40:60 or about 40:60. In some embodiments, the ratio is equal to or lower than 30:70 or about 30:70. In some embodiments, the ratio is equal to or lower than 20:80 or about 20:80. In some embodiments, the ratio is equal to or lower than 10:90 or about 10:90.

In certain embodiments, the ratio of ratio between the Polyketide pigment (such as an azaphilone) and tocopherol (especially soluble tocophenol) may be from 10:90 to 99:1 or from about 10:90 to about 99:1, from 10:90 to 90:1 or from about 10:90 to about 90:1, from 20:80 to 80:20 or from about 20:80 to about 80:20, from 50:50 to 80:20 or from about 50:50 to about 80:20, or from 60:40 to 80:20 or from about 60:40 to about 80:20.

In certain embodiments, the ratio of ratio between the Polyketide pigment (such as an azaphilone) and soluble or dispersible tocopherol may be equal to or greater than 10:90 or about 10:90. In some embodiments, the ratio is equal to or greater than 20:80 or about 20:80. In some embodiments, the ratio is equal to or greater than 30:70 or about 30:70. In some embodiments, the ratio is equal to or greater than 40:60 or about 40:60. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In certain embodiments, the Polyketide pigment (such as an azaphilone) is contacted with two or more of the products (ii).

The inventors of the present invention have proved a synergetic effect of tocopherol and rosmarinic acid (such as lemon balm extract) in protecting and stabilizing to the light exposure the Polyketide pigment (such as an azaphilone).

Therefore, the invention provides a method for stabilizing the colour of a Polyketide pigment (such as an azaphilone) comprising contacting (i) a Polyketide pigment with (ii) rosmarinic acid and/or a tocopherol, wherein the resulting Polyketide pigment (such as an azaphilone) is light stable.

The invention also provides a method for producing a light stable Polyketide pigment (such as an azaphilone) that comprises the steps of: contacting (i) a Polyketide pigment with (ii) rosmarinic acid, and/or a tocopherol, and optionally b) mixing (i) and (ii).

The resulting colouring composition comprises a Polyketide pigment and rosmarinic acid and/or a tocopherol. In a preferred embodiment, the tocopherol is water dispersible.

The ratio between rosemaric acid and tocophenol may be equal to or greater than 15:1 or about 15:1.

In some embodiments, the ratio is equal to or greater than 10:1 or about 10:1. In some embodiments, the ratio is equal to or greater than 20:1 or about 20:1. In some embodiments, the ratio is equal to or greater than 30:1 or about 30:1. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

Synergetic effect of Gamma cyclodextrin and lemon balm

The inventors of the present invention have proved a synergetic effect of Gamma cyclodexrin and rosmarinic acid (such as lemon balm extract) in protecting and stabilizing to the light exposure the Polyketide pigment (such as an azaphilone).

Therefore, the invention provides a method for stabilizing the colour of a Polyketide pigment (such as an azaphilone) comprising contacting (i) a Polyketide pigment with (ii) rosmarinic acid and/or a cyclodexrin, specially gamma cyclodextrin, wherein the resulting Polyketide pigment (such as an azaphilone) is light stable.

The invention also provides a method for producing a light stable Polyketide pigment (such as an azaphilone) that comprises the steps of: contacting (i) a Polyketide pigment with (ii) rosmarinic acid, and/or a cyclodextrin, specially gamma cyclodextrin, and optionally b) mixing (i) and (ii).

The resulting colouring composition comprises a Polyketide pigment and rosmarinic acid and/or a cyclodexrin, specially gamma cyclodextrin. In a preferred embodiment, the tocopherol is water soluble.

The ratio between rosemaric acid and cyclodexrin, specially gamma cyclodextrin, may be equal to or greater than 15:1 or about 15:1.

In some embodiments, the ratio is equal to or greater than 10:1 or about 10:1. In some embodiments, the ratio is equal to or greater than 20:1 or about 20:1. In some embodiments, the ratio is equal to or greater than 30:1 or about 30:1. In some embodiments, the ratio is equal to or greater than 50:50 or about 50:50. In some embodiments, the ratio is equal to or greater than 60:40 or about 60:40. In some embodiments, the ratio is equal to or greater than 70:30 or about 70:30. In some embodiments, the ratio is equal to or greater than 80:20 or about 80:20. In some embodiments, the ratio is equal to or greater than 85:15 or about 85:15. In some embodiments, the ratio is equal to or greater than 90:10 or about 90:10. In some embodiments, the ratio is equal to or greater than 95:5 or about 95:5. In some embodiments, the ratio is equal to or greater than 99:1 or about 99:1.

In a further aspect, the invention is related to a colouring composition comprising a stabilized Polyketide pigment (such as an azaphilone) obtained using the method of the invention.

The colouring composition of the invention may further comprise carriers.

Suitable carriers include inert solid diluents or fillers, sterile aqueous solutions and various organic solvents. Examples of solid carriers are lactose, terra alba, sucrose, cyclodextrin, maltodextrin, dextrin, talc, gelatine, agar, pectin, acacia, magnesium stearate, magnesium hydroxide; stearic acid, arabic gum, modified starch and lower alkyl ethers of cellulose, saccharose, silicon dioxide. Examples of liquid carriers are syrup, vegetables oils, phospholipids, fatty acids, fatty acid amines, polyoxyethylene and water. Moreover, the carrier or diluent may include any sustained release material known in the art, such as glyceryl monostearate or glyceryl distearate, alone or mixed with a wax.

In a further aspect, the invention is related to a stabilized colouring composition comprising a mixture of a Polyketide pigment (such as an azaphilone) and at least one product (ii) selected from a carotenoid (such as lycopene, bixin and/or norbixin), rosmarinic acid, a chlorogenic acid, rutin glucoside, (gamma) cyclodextrin and/or a tocopherol. The stabilized pigment of the invention may be obtained using the method of the invention. As mentioned before, the Polyketide pigment (such as an azaphilone) and at least one product (ii) selected from a carotenoid (such as lycopene, bixin and/or norbixin), rosmarinic acid, a chlorogenic acid, rutin glucoside, cyclodextrin (such as gamma cyclodextrin) and/or a tocopherol may be in form or solids, then mixed and after they can be then solubilized in a suitable solvent. Also, as already mentioned before, both components of the stabilized colouring composition of the invention may be provided as a liquid form and thus directly mixed in a liquid form. Any method know in the art may be used to mix both components of the stabilized composition of the invention.

In certain embodiments, the stabilized Polyketide pigment (such as an azaphilone) of the invention has a colour with a maximum absorption band at 480 nm+−5 nm.

In certain embodiments, the stabilized Polyketide pigment (such as an azaphilone) of the invention has a colour with a maximum absorption band from 300+/−5 nm to 450 nm+/−5 nm (yellow pigments)

In certain embodiments, the stabilized Polyketide pigment (such as an azaphilone) of the invention has a colour with a maximum absorption band from 350+/−5 nm to 500 nm+/−5 nm (orange pigments)

In certain embodiments, the stabilized Polyketide pigment (such as an azaphilone) of the invention has a colour with a maximum absorption band from 450+/−5 nm to 600 nm+/−5 nm (red pigments)

All embodiments related to the Polyketide pigments defied previously for the methods of the invention, also apply for the stabilized Polyketide pigment (such as an azaphilone) and stabilized colouring composition of the invention. Also, all embodiments related to the product (ii) defied previously for the methods of the invention, also apply for the stabilized Polyketide pigment (such as an azaphilone) and stabilized colouring compositions of the invention.

In a preferred embodiment, the stabilized Polyketide pigment (such as an azaphilone) and stabilized colouring composition of the invention comprises one or more of the azaphilone pigments monascin, ankaflavin, monascorubrin, rubropunctatin, monascorubramine, rubropuntamine, atrorosin(s) and their derivates,

In certain embodiments, the stabilized colouring composition of the invention has a colour with a maximum absorption band at 380 nm+−5 nm.

In certain embodiments, the stabilized colouring composition of the invention has a colour with a maximum absorption band at 450 nm+/−5 nm.

In certain embodiments, the stabilized colouring composition of the invention has a colour with a maximum absorption band at 500 nm+/−5 nm.

In certain embodiments, the stabilized colouring composition of the invention has a colour with a maximum absorption band at 520 nm+/−5 nm.

The stabilized colouring compositions of the invention may further comprise other pigments such as

### Foodstuff, Nutritional Supplement, Nutraceutical, Perfume or Cosmetic Composition and Method of Production Thereof.

The stabilized colouring composition of the invention may be used to provide a colour to any consumer product where a stable red, orange or yellow is desirable.

Therefore, in a further aspect, the invention is related to a method for stabilizing the colour of a foodstuff, a pharmaceutical, a nutraceutical, a perfume or a cosmetic product comprising the steps of incorporating a stabilized pigment or a stabilized colouring composition of the invention to a foodstuff, a pharmaceutical, a nutraceutical, a perfume or a cosmetic product. In a preferred embodiment, the colour being stable to light exposure.

The components (i) and (ii) may be formulated together and may be incorporated to the product at any stage of the production of said product.

The present inventors have observed that both components (i) and (ii) to deliver a more stable colorant need to be premixed. Without being bound to any theory, it is believed that the Polyketide pigment (such as a monascus or monascus like pigments) are stabilized by the second component (ii) and that to have this stabilization a premix of the components in needed before the stabilized colorant is mixed with the product (food, cosmetic etc). As it can be seen from example 7, if both components are added separately to the product matrix (without a premix that allows the stabilization to occur), the Polyketide pigment (such as a monascus or monascus like pigments) is not stable. However, some matrixes that are liquid could allow the mix and the complexation of the both components (i) and (ii) “in situ” (i.e directly in the matrix) without a previous step of mixing and formulating the both components together.

Therefore, in certain embodiments, when the product is in liquid or semisolid form (such as beverages, dairy products like milks, yogurts, creams, etc) the both components (i) and (ii) may be added separately, that is one after the other without forming a blend or a premix.

Therefore, in a further aspect, the invention is related to a method for producing a foodstuff, a pharmaceutical, a nutraceutical, a perfume or a cosmetic product comprising the steps of incorporating components (i) and component (ii) as defined in any one of the previous claims, wherein component (i) is added directly to the product and consequently product (ii) is also added to the product or wherein component (ii) is added directly to the product and consequently product (i) is also added to the product, especially when the product is a liquid or a semisolid.

All embodiments already mentioned for the pigment or the colouring composition of the invention also applies for the methods of the invention.

In another aspect, the invention relates to a foodstuff, a pharmaceutical, a nutritional supplement, a nutraceutical, a perfume or a cosmetic product comprising a stabilized pigment or a stabilized colouring composition as defined in the present document that comprises a mixture of a Polyketide pigment (such as an azaphilone) and at least one product (ii) selected from a carotenoid (such as lycopene, bixin and/or norbixin), rosmarinic acid, a chlorogenic acid, rutin glucoside, cyclodextrin and/or a tocopherol, and, optionally a vehicle adequate for the formulation of the composition into said foodstuff, a pharmaceutical, a nutritional supplement, a nutraceutical, a perfume or a cosmetic product.

Thus, the present invention is related to a foodstuff, a pharmaceutical, a nutritional supplement, a nutraceutical, a perfume or a cosmetic product comprising a stabilized pigment or a stabilized colouring composition as defined in the present document, wherein the colour of the foodstuff, a pharmaceutical, a nutritional supplement, a nutraceutical, a perfume or a cosmetic product is stable to light exposure. In a preferred embodiment, the pigment or colouring composition of the invention is obtained using the method of the invention. In certain embodiments, the foodstuff, pharmaceutical, nutraceutical, perfume or cosmetic product obtained using the methods of the invention, characterized by having a red, orange or yellow colour that is stable to light

In the present invention, the term “stable to light” or “stable to light exposure” means that the colour hue provided by the stabilized pigment of the invention or the stabilized colouring composition of the invention is not changed or has a change of less than 30% in respect to the colour hue measured at dark conditions. Thus, in certain embodiments the colour provided by the colouring composition of the invention is stable after a light exposure of more than 5 minutes, such as more than 30 minutes, such as more than 1 hour, such as more than 2 hours, 5 hours, 10 hours, 12 hours, 24 hours, 2 days, 10 days, such as more than 30 days, or such as more than 60 days or more than 6 months.

Food or foodstuff encompasses the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, and cocktail mix; beverages and beverage bases, non-alcoholic, including only special or spiced teas, soft drinks, coffee substitutes, and fruit and vegetable flavoured gelatin drinks; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavoured frosting, marshmallows, baking chocolate, and brown, lump, rock, maple, powdered, and raw sugars; toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; pastas, including macaroni and noodle products, rice dishes, and frozen multicourse meals, without meat or vegetables; gravies and sauces, including all meat sauces and gravies, and tomato, milk, buttery, and specialty sauces; herbs, seeds, spices, seasonings, blends, extracts, and flavourings, including all natural and artificial spices, blends, and flavours; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavoured milks and milk drinks, dry milks, toppings, snack dips, spreads, weight control milk beverages, and other milk origin products; plant protein products, including the National Academy of Sciences/National Research Council “reconstituted vegetable protein” category, and meat, poultry, and fish substitutes, analogues, and extender products made from plant proteins; poultry products, including all poultry and poultry-containing dishes, salads, appetizers, frozen multicourse poultry meals, and sandwich ingredients prepared by commercial processing or using commercially processed poultry with home preparation; all commercially processed vegetables, vegetable dishes, frozen multicourse vegetable meals, and vegetable juices and blends; snack foods, including chips, pretzels, and other novelty snacks; soups, home-prepared, including meat, fish, poultry, vegetable, and combination home-prepared soups; soups and soup mixes, including commercially prepared meat, fish, poultry, vegetable, and combination soups and soup mixes.

A “Nutraceutical” as used herein relates to a compound that beneficially affects one or more functions of the body, so as to provide better health and wellness. Accordingly, such a nutritional supplement may be intended for the prevention and/or treatment of a disease or a disease-causing factor. Therefore, the term “nutritional composition” of the present invention can be used as a synonym for functional food or foods for particular nutritional purposes, or medical food. A nutritional composition is similar to that of a conventional food and consumed as part of a normal diet appearance. In a preferred embodiment, the nutraceutical is a Nutritional supplement.

As used herein, the term “nutraceutical supplement or nutraceutical product” refers to a product suitable for use in human beings or animals, comprising one or more natural products with therapeutic action which provide a health benefit or have been associated with disease prevention or reduction, and it includes dietary supplements presented in a non-food matrix (e.g., capsules, powder, etc.) of a concentrated natural bioactive product usually present (or not) in the foods and which, when taken in a dose higher than that existing in those foods, exerts a favorable effect on health which is greater than effect which the normal food may have. Therefore, the term “nutraceutical product” includes isolated or purified food products as well as additives or food supplements which are generally presented in dosage forms normally used orally, for example, capsules, tablets, sachets, drinkable phials, etc.; such products provide a physiological benefit or protection against diseases, generally against chronic diseases.

“Pharmaceutical product”, as used herein, relates to compositions and molecular entities that are physiologically tolerable. Preferably, the term “pharmaceutically acceptable” means it is approved by a regulatory agency of a state or federal government or is included in the U.S. Pharmacopoeia or other generally recognized pharmacopoeia for use in animals, and more particularly in humans.

“Cosmetic product”, as used herein refers to a composition suitable for use in personal hygiene of human beings or animals, or in order to enhance the natural beauty or change the body appearance without affecting the structure or functions of the human or animal body, comprising one or more products providing such effects. If desired, the cosmetic composition provided by the invention can contain, in addition to the composition of the invention, one or more cosmetics or cosmetic products, i.e., substances or mixtures intended to be placed in contact with the external parts of the human or animal body (e.g., epidermis, hair system, nails, lips, etc.) or with the teeth and the buccal mucosa, for the exclusive or main purpose of cleaning them, perfuming them, changing their appearance, protecting them, keeping them in good condition or correcting body odors. Illustrative examples of cosmetically acceptable vehicles include the products contained in the INCI (International Nomenclature of Cosmetic Ingredients) list. The composition of the present invention may be added to a wide variety of products for cosmetic application, including makeup, creams for cleansing, protecting, treating, or caring for the skin, in particular, the face, hands, and feet (e.g., day and night creams, makeup removal creams, foundation creams and sunscreens), liquid foundations, makeup removal lotions, protective or skin-care body lotions, sunscreen lotions, skin care lotions, gels, or foams, such as cleansing, sunscreen, and artificial tanning lotions, bath preparations, deodorant compositions, after-shave gels or lotions, depilatory creams, and compositions used for insect stings and against pain. The composition of the invention may take any of a wide variety of forms, and include, for example dressings, lotions, solutions, sprays, creams, gels, ointments, or the like.

The stabilized pigment or the colouring composition of the invention can be added in an amount effective to increase, enhance and/or modify the colour characteristics of a product (such as a foodstuff) or portion thereof. In certain embodiments, stabilized pigment or the colouring composition of the invention can be added in an amount effective to achieve a desired effect such as imparting a particular red, orange or yellow colour that is stable to light exposure.

For example, the food colouring composition as described hereinbefore can be used to impart a red colour similar to the colour obtained when using carmine or an artificial colour to food products, such as dairy, confectionery, beverages, sauces/gravies, etc.

A dairy product may refer to yogurt, custard, milk smoothie, milk shake, dairy ice cream.

A confectionery product may refer to a sweet or candy food product, such as chewing gums or hard and soft confectionery products. Non-limiting examples of confectionery products include cakes, cookies, pies, chocolates, chewing gums, gelatins, ice creams, puddings, jams, jellies, gummies, hard boiled candies, chewy candies, cereal and other breakfast foods, canned fruits and fruit sauces.

A beverage product may refer to beverages, beverage mixes and concentrates, including but not limited to alcoholic and non-alcoholic ready to drink and dry powdered beverages. Non-limiting examples of beverages can include carbonated and non-carbonated beverages, e.g., sodas, fruit or vegetable juices.

A sauce product may refer to a sweet or savoury semi-solid composition used to add flavour, moisture and/or visual appeal to a dish. Non-limiting examples of sauces include gravy and barbecue sauce.

A meat analogue product may refer to foods made from vegetarian ingredients, which approximate certain aesthetic qualities (such as texture, flavour, appearance) or chemical characteristics of specific types of meat. Non-limiting examples of meat analogues include vegetable (veggie) burgers.

One of ordinary skill in this art will recognize that the optimal amount of food colouring composition present in a given food product is determined by factors such as overall desired colour, solubility, regulatory approval, etc. One of ordinary skill in this art can readily determine the optimal amount of colour for a given product based on those factors.

In certain embodiments, the product (a foodstuff, a pharmaceutical, a nutritional supplement, a nutraceutical, a perfume or a cosmetic product) is packaged in a transparent or semi-transparent packaging.

### KIT

The present invention also relates to a kit comprising the different elements of the colouring compositions of the invention, and optionally instructions on how to mix, prepare and/or use said ingredients. In certain embodiments, the kit comprises the elements already mixed and ready to use (for example as a blend) and optionally instructions of how to use said ingredients. In certain embodiments, the kit comprises other colours such as yellow or red colours.

### Colour Evaluation

The colouring compositions and the products comprising the colouring compositions of the present disclosure can be analyzed with a spectrophotometer, and CIELAB L*a*b* values can be calculated from the spectral data, as described in greater detail below. The L*a*b* values provide a means of representing colour characteristics and assessing the magnitude of difference between two colours. The L*a*b* values also provide a means of representing colour characteristics and assessing the magnitude of difference between two colours not only of solutions, but also of products. Measurements of colour compositions and products in solid form are accomplished using reflectance measurements from the surface of the product.

For example, L*a*b* values consist of a set of coordinate values defined in a three-dimensional Cartesian coordinate system. L* is the lightness coordinate and provides a scale of lightness from black (0 L* units) to white (100 L* units) on a vertical axis. a and b* are coordinates related to both hue and chroma. a* provides a scale for greenness (−a* units) to redness (+a* units), with neutral at the center point (0 a* units), on a horizontal axis; b* provides a scale for blueness (−b* units) to yellowness (+b* units), with neutral at the center point (0 b* units), on a second horizontal axis perpendicular to the first horizontal axis. The three axes cross where L* has a value of 50 and a* and b* are both zero.

ΔE is a measure of the magnitude of total colour difference between two colours represented in CIELAB L*a*b* colour space. It has been reported that an experienced colour observer cannot distinguish any difference between two colours when the ΔE is about 2.3 or less. The ΔE of two different colours with L*a*b* values, L*₁a*₁b*₁ and L*₂a*₂b*₂, is calculated using Equation 1:

$$Δ {{E}_{ab}}^{*} = \sqrt{{( {{L}^{*}}_{1} - {{L}^{*}}_{2} )}^{2} + {( {{a}^{*}}_{1} - {{a}^{*}}_{2} )}^{2} + {( {{b}^{*}}_{1} - {{b}^{*}}_{2} )}^{2}} \qquad Equation 1$$

The present invention is further illustrated by means of the following non-limiting examples.

### EXAMPLES

### Materials and Methods

### Materials and Methods:

Monascus extract: Pigment was purchased from CNJ Nature, according to the supplier, red pigment was obtained from fermented rice and extracted with ethanol, purified then formulated with malto dextrin and finally spray dried, pigment content is around 71%
Water-soluble Rutin: Sophora japonica extract was enzymatically glycosylated, this reaction added sugars to rutin backbone which made it water-soluble (FIG. 2), final product was formulated on water-glycerol carrier and contains 4.5% of Rutin glucoside.

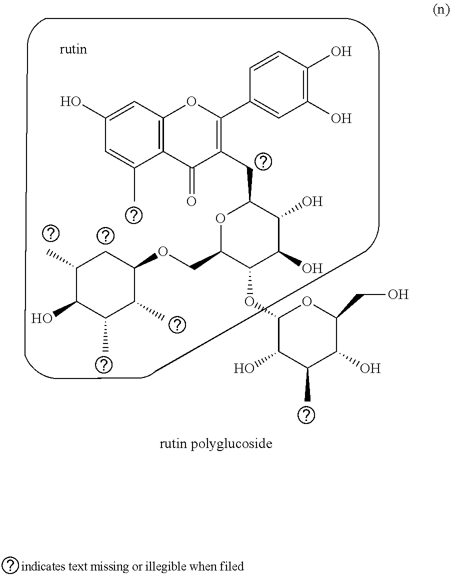 [SMILES: Cc1cc(O)cc2oc(-c3ccc(O)c(O)c3)c(C[C@@H]3O[C@H](CO[C@@H]4C[C@@H](C)[C@H](O)[C@@H](C)[C@H]4C)[C@@H](O[C@@H]4O[C@@H](CO)[C@H](O)[C@@H](C)[C@@H]4O)[C@H](O)[C@H]3O)c(=O)c12]

### Rutin Polyglucoside Structure

Lemon balm (4-7%): Melissa Officinalis was extracted twice with ethanol (70%) and purified using charcoal, after concentration the product was blended with Monopropylene glycol to obtain 4-7% of rosmarinic acid.
Water dispersible Tocopherol: Tocopherol was formulated using water and gum arabic then spray dried to form dry emulsion. Final concentration of tocopherol is 15%.
Lycopene suspension: Lycopene was purchased from Lycored. Lycopene was extracted from tomato using Ethyl acetate an ethanol, after purification and concentration final product was formulated on glycerol, lecithin, sucrose ester and water, final pigment content is 2%.
Green bean coffee: chlorogenic acid was extracted using mixture of water and ethanol, purified than formulated on maltodextrin final concentration of chlorogenic acid was 4.5%.
Gamma cyclodextrin: product was purchased from sigma Aldrich and has purity>98% Cas number 17465-86-0

### Example 1: Improvement of Monascus Light Stability Using Lycopene

Solution 1A: 0.03 g of Monascus extract powder (71% of pigment) was mixed with 0.015 g of Lycopene suspension (2% of lycopene), the blend was introduced in 99.95 g of DI water (solution 1A).

(1A) solution was measured on the spectrophotometer (Konica Minolta) for evaluation of initial L,a,b parameters and set as a reference. For pigment retention calculation, initial Absorption at 490 nm was also recorded.

Samples were then submitted to light stress using SUNTEST cps+ (350w/m2, at 4° C. during 26 h), kinetics of degradation were measured by displaying the pigment retention R and dE2000

As control, solutions of monascus alone (1B) and lycopene alone (1C) were simultaneously irradiated with solution (1A).
1B composition: 0.03% Monascus extract, 99.97% water
1C composition: 0.015% Lycopene suspension, 99.98% water

As previously explained, kinetics of Monascus degradation was illustrated by the evolution of colour variation DE2000 and pigment retention at 490 nm where:

$$\% Monascus retention = \frac{{Abs}_{t}^{490 nm}}{{Abs}_{t 0}^{490 nm}} \times 100$$

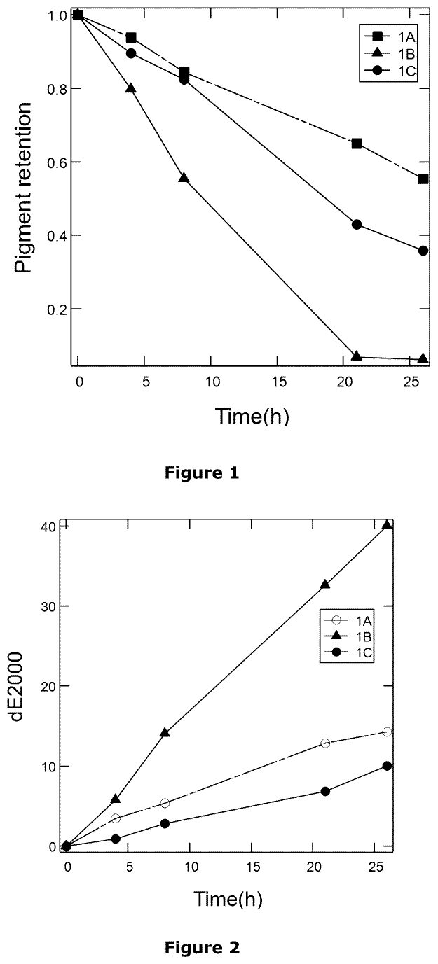

Results. As seen in FIGS. 1 and 2, the light stability of the Solution 1A (mixture of monascus with Lycopene) is increased.

FIG. 1 shows that light irradiation induced a drastic degradation of the Monsacus molecules, surprisingly Mixing with lycopene introduced a protective effect on Monsacus which was reflected by an enhancement of colour retention from 6% (control) to 55% in mixture which yield to smaller color change (dE2000) (FIG. 2). Without a bound to any theory, we assume that lycopene is exhibiting a protective effect on monascus (sacrificial chromophore)

### Example 2: Screening of Polyphenols for Light Stabilization

Example 0.03 g of Monascus extract powder (71% of pigment) was mixed with 0.15 g to 1 g of water soluble polyphenols the blend was introduced in of DI water to reach final concentration of 0.03% of Monascus extract. Solutions were measured on the spectrophotometer (Konica Minolta) for evaluation of initial L,a,b parameters and set as a reference. For pigment retention calculation, initial Abs at the maximum wavelength (490 nm) was also recorded.

Samples were then submitted to light stress using SUNTEST cps+ (350w/m2, T4° C.) during 20 h, kinetic of degradation was measured by displaying the pigment retention R and DE2000 during irradiation. 20 hours of this condition would correspond to about 20 days at normal light store conditions in a supermarket.

$$2 A composition : 0.03 \% Monascus extract + 99.97 \% water$$

$$2 B composition : 0.03 \% Monascus + 0.15 \% Lemon balm extract ( extacted with ethanol ) + 1 \% water soluble rutin ( 4 \% Rutin glucoside ) + 98.82 \% water .$$

$$2 C composition : 0.03 \% Monascus + 0.15 \% lemon balm extract ( extracted with ethanol ) + 99.82 \% water .$$

$$2 D composition : 0.03 \% Monascus + 0.15 \% green bean coffee extract + 99.82 \% water .$$

$$2 E composition : 0.03 \% Monascus + 0.15 \% green bean coffee extract + 1 \% water soluble rutin ( 4 \% Rutin glucoside ) + 98.82 \% water .$$

$$2 F composition : 0.03 \% Monascus + 1 \% water soluble rutin ( 4 \% Rutin glucoside ) + 98.87 \% water .$$

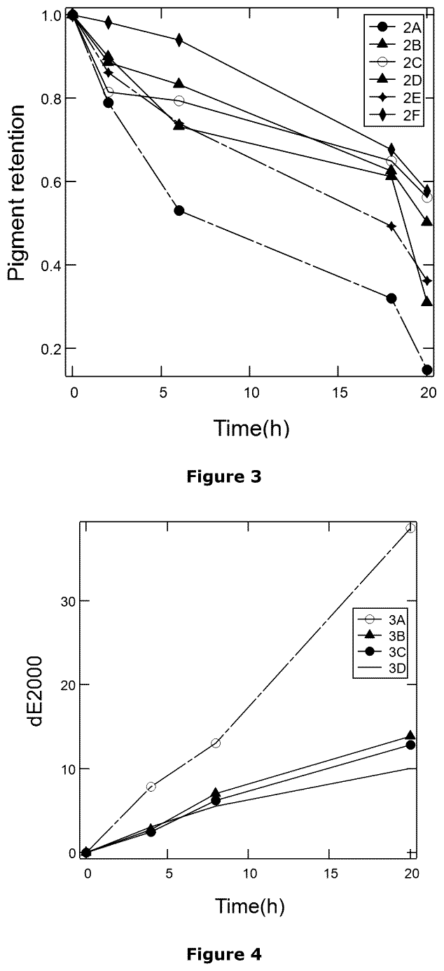

Results: as found in example 1, FIG. 3 show that light irradiation induced a drastic degradation of the Monsacus molecules, surprisingly Mixing with rutin glycoside introduced a protective effect on Monsacus which was reflected by an enhancement of colour retention from 10% (control) to 57% in mixture.

A stabilizing effect was also found upon using lemon balm extract (ethanolic extract) where monasus retention was increased up to 56% which yield to smaller color change (dE2000) (FIG. 4)

### Example 3: Screening of Different Ratios of Lemon Balm

0.03 g of Monascus extract powder (71% of pigment) was mixed with 0.1 to 0.4 g of lemon balm extract, the blend was introduced in DI water to reach final concentration of 0.03% of Monascus extract. Solutions were measured on the spectrophotometer (Konica Minolta) for evaluation of initial L,a,b parameters and set as a reference. For pigment retention calculation, initial Abs at the maximum wavelength (490 nm) was also recorded.

Samples were then submitted to light stress using SUNTEST cps+ (350w/m2) T4° C.), kinetic of degradation was measured by displaying the pigment retention R and DE00 during irradiation (25 h)

$$3 A composition : 0.03 \% Monascus extract + 99.97 \% water$$

$$3 B composition : 0.03 \% Monascus + 0.1 \% lemon balm extract ( 7 - 15 \% of rosmarinic acid ) + 99.87 \% water .$$

$$3 C composition : 0.03 \% Monascus + 0.2 \% lemon balm extract ( 7 - 15 \% of rosmarinic acid ) + 99.77 \% water .$$

$$3 D composition : 0.03 \% Monascus + 0.4 \% lemon balm extract ( 7 - 15 \% of rosmarinic acid ) + 99.57 \% water .$$

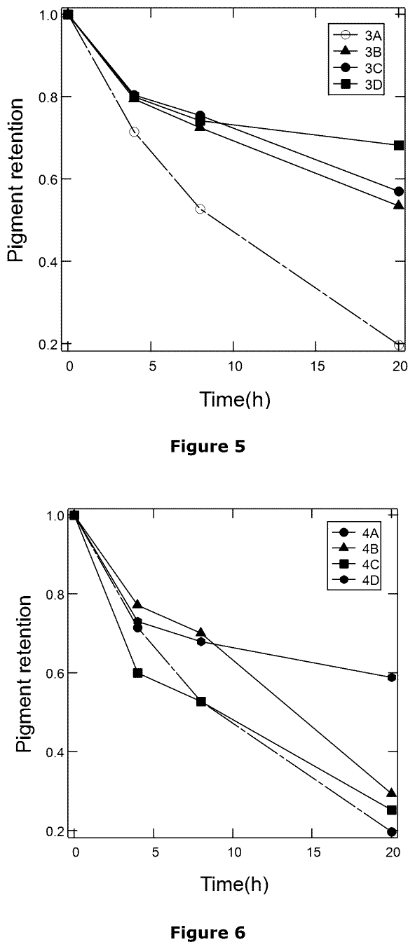

Results: as it can be seen in FIGS. 6, increasing the dosage of lemon balm extract improved the pigment retention up to 70% at 0.4% of lemon balm, which yield to smaller colour change (dE2000) FIG. 5

### Example 4: Screening of Different Ratios of Water Dispersible Tocopherol

0.03 g of Monascus extract powder (71% of pigment) was mixed with 0.01 g to 0.1 g of tocopherol powder (15% of Tocopherol), the blend was introduced in DI water to reach final concentration of 0.03% of Monascus extract. Solutions were measured on the spectrophotometer (Konica Minolta) for evaluation of initial L,a,b parameters and set as a reference. For pigment retention calculation, initial Abs at the maximum wavelength (490 nm) was also recorded.

Samples were then submitted to light stress using SUNTEST cps+ (350w/m\hat{ }2, T4° C.), kinetic of degradation was measured by displaying the pigment retention R and DE00 during irradiation

$$4 A composition : 0.03 \% Monascus extract + 99.97 \% water .$$

$$4 B composition : 0.03 \% Monascus + 0.01 \% water dispersible tocopherol ( 15 \% tocopherol content ) + 99.96 \% water .$$

$$4 C composition : 0.03 \% Monascus + 0.05 \% water dispersible tocopherol ( 15 \% ) + 99.92 \% water .$$

$$4 D composition : 0.03 \% Monascus + 0.1 \% water dispersible tocopherol ( 15 \% ) + 99.87 \% water .$$

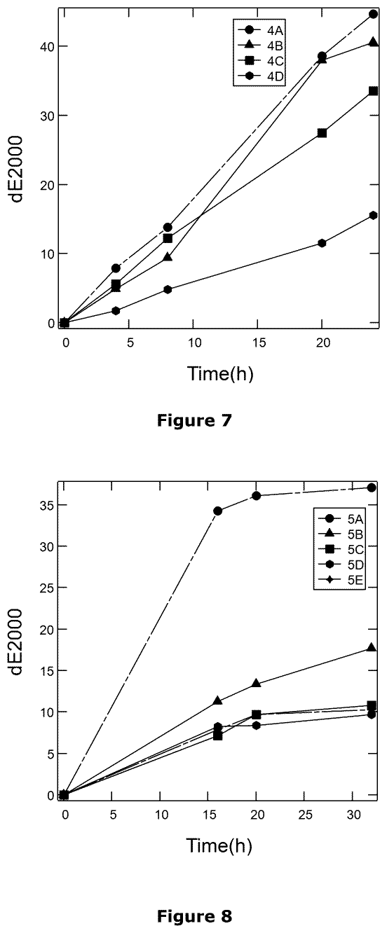

Results: as it can be seen in FIG. 7, increasing the dosage of tocopherol improved the pigment retention up to 60% at 0.1% of tocopherol, which yields to smaller colour change (dE2000) FIG. 8.

### Example 5: Synergetic Effect of Tocopherol and Lemon Balm

0.03 g of Monascus extract powder (71% of pigment) was mixed with to 0.25 g of lemon balm extract and different ratios of water dispersible tocopherol the blend was introduced in of DI water to reach final concentration of 0.03% of Monascus extract. Solutions were measured on the spectrophotometer (Konica Minolta) for evaluation of initial L,a,b parameters and set as a reference. Samples were then submitted to light stress using SUNTEST cps+ (350w/m\hat{ }2, T4° DE2000 was measured after 20 h of light irradiation irradiation.

$$5 A composition : 0.03 \% Monascus extract + 99.97 \% water$$

$$5 B composition : 0.03 \% Monascus + 0.25 \% lemon balm ( 7 - 14 \% rosmarinc acid ) + 99.96 \% water .$$

$$5 C composition : 0.03 \% Monascus + 0.25 \% lemon balm ( 7 - 14 \% rosmarinc acid ) + 0.02 \% water dispersible tocopherol ( 15 \% ) + 99.7 \% water .$$

$$5 D composition : 0.03 \% Monascus + 0.25 \% lemon balm ( 7 - 14 \% rosmarinc acid ) + 0.05 \% water dispersible tocopherol ( 15 \% ) + 99.7 \% water .$$

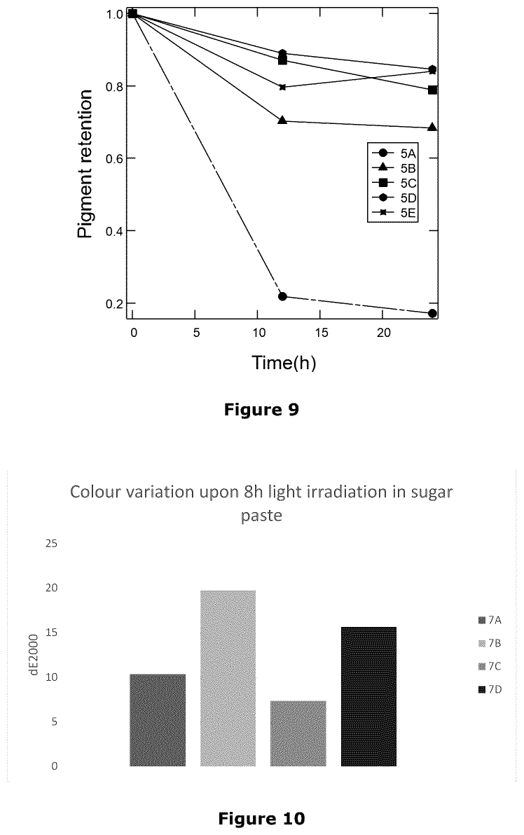

Results: as it can be seen in FIGS. 10, mixing tocopherol with Lemon balm improved the pigment retention up to 84% at 0.025% and 0.05% of tocopherol and 0.25% of lemon balm, which yields to smaller color change (dE2000) FIG. 9. This results suggests that there is a synergetic effect of protection against light between lemon balm and tocopherol

### Example 6: Synergetic Effect of Gamma Cyclodextrin and Lemon Balm

0.03 g of Monascus extract powder (71% of pigment) was mixed with to 0.2 g of lemon balm extract (ethanolic extract (4-7% rosmarinic acid) or 0.2 g of gamma cyclodextrine (purchased from sigma, 98% of purity) a mixture of lemon balm extract and gamma cyclodexrin was also tested (composition above). Blends were introduced in of DI water to reach final concentration of 0.03% of Monascus extract. Solutions were measured on the spectrophotometer (Konica Minolta) for evaluation of initial L,a,b parameters and set as a reference. Samples were then submitted to light stress using SUNTEST cps+ (350w/m2, T4C) DE2000 was measured after 15 h of light irradiation

$$6 A composition : 0.03 \% Monascus extract + 99.97 \% water .$$

$$6 B composition : 0.03 \% Monascus + 0.2 \% lemon balm ( 4 - 7 \% rosmarinic acid ) + 99.95 \% water .$$

$$6 C composition : 0.03 \% Monascus + 0.2 \% gamma - cyclodextrine + 99.95 \% water .$$

$$5 D composition : 0.03 \% Monascus + 0.2 \% lemon balm ( 4 - 7 \% rosmarinic acid ) + 0.2 \% gamma cyclodextrine + 99.57 \% water .$$

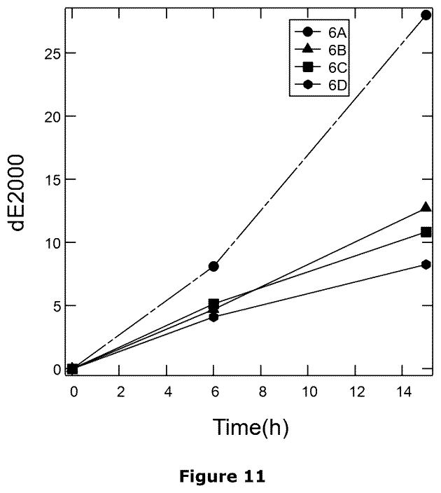

Results: as it can be seen in FIGS. 11, cyclodextrin can improve pigment stability. Surprisingly upon mixing Lemon balm with gamma-cyclodextrin pigment stability was improved which yields to smaller color change (dE2000). This results suggests that there is a possible synergetic effect of protection against light between lemon balm and cyclodextrin

Without a bound to any theory, we believe that lemon balm is protecting against light degradation upon oxygen scavenging and UV light filtering, from the other side gamma-cyclodextrin is giving a protective effect upon hosting partially carbon chain of monascus in the hydrophobic cavity of cyclodextrin

### Example 7: Stabilization Using Lycopene in Sugar Paste Matrix

Example 7 was performed to investigate the importance ingredients of mixing for stabilization of monascus.

Sample 7A: 0.03 g of Monascus extract powder (71% of pigment) was mixed with 0.015 g of Lycopene suspension (2% of lycopene), mixed with 300 μL of DI water, the blend was introduced in 99.95 g of sugar paste water (sample 7A).

Samples were measured on the spectrophotometer (Konica Minolta) for evaluation of initial L,a,b parameters and set as a reference.

Samples were then submitted to light stress using SUNTEST cps+ (350w/m2, at 4° C. during 8 h), kinetics of degradation were measured by displaying the pigment retention R and dE2000

As control, samples of monascus alone (7B) and lycopene alone (7C) and non-mixed monascus and lycopene (7D) were simultaneously irradiated with solution (7A).
7B composition: 0.03% Monascus extract, 99.97% sugar paste
7C composition: 0.015% Lycopene suspension, 99.98% sugar paste
7D composition: 0.03% Monascus extract incorporated first in sugar paste then 0.015% of lycopene was added to 99.98% sugar paste without prior mixing as in 7A

As we can see in graph 11, prior mixing of lycopene and monsacus gave better retention against light stress.

1. A method for stabilizing the colour of a Polyketide pigment comprising contacting (i) a Polyketide pigment with (ii) a carotenoid, rosmarinic acid, rutin glucoside, cyclodextrin and/or a tocopherol, wherein the resulting Polyketide pigment is light stable.

2. The method according to claim 1, wherein the Polyketide is selected from azaphilones, anthraquinones, hydroxyanthraquinones and/or naphthaquinones.

3. The method according to claim 1, wherein the azaphilone is selected from one or more of nitrogenated azaphilones, austdiols, spiciferinone and derivatives, deflectins, helotialins, bulgarialactones, spiro-azaphilones, O-substituted azaphilones lactone azaphilones, hydrogenated azaphilones, chaetoviridins and chaetomugilins, sequoiatones, tricoflectin and sassafrin azaphilones, pulvilloric acid-type azaphilones, sclerotiorins, multiformins and cohaerins, ascochitine, chrysodin-type azaphilones, hydrogenated spiro azaphilones, chlorofusins, atrorosins, N-containing Monascus pigments, atrorosin-type azaphilone.

4. The method according to claim 3, wherein the azaphilone is selected from monascin, ankaflavin, monascorubrin, rubropunctatin, monascorubramine, rubropuntamine, and/or monascorubraminic acid (compound of formula (I)), and any of their derivatives, 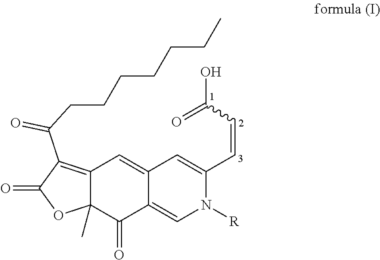
wherein in the monascorubramine (C23H27NO4), rubropunctamine (C21H23NO4) and monascorubraminic acid the N—R is selected from the group consisting of an amino acid, a peptide, an amino sugar and a primary amine,
and wherein the wavy bond is indicating an unspecified configuration of the adjacent double bond between carbon 2 and 3.

5. The method according to claim 1, wherein the Polyketide is obtained from one or more of the fungal genera Aspergillus genus, Chaetomium genus, Hypoxylon genus, Monascus genus, Muycopron genus, Penicillium genus, Phomopsis genus, Pleosporales genus, Talaromyces genus, Pestalotiopsis genus, Phomopsis genus, Emericella genus, Epicoccum genus and or Hypoxylon genus.

6. The method according to claim 5, wherein the Talaromyces is Talaromyces atroroseus.

7. The method according to claim 1, where the Polyketide pigment is extracted unmodified from its natural state, or taken from its natural state and purified or chemically modified.

8. The method according to claim 1, where the Polyketide pigment is a mixture or is a single compound.

9. The method according to claim 1, wherein the carotenoid is selected from lycopene, bixin, norbixin or mixtures thereof.

10. The method according to claim 9, wherein the lycopene is in the form of crystals.

11. The method according to claim 9, wherein in addition to lycopene, bixin and/or norbixin one or more of rosmarinic acid, rutin glucoside, cyclodextrin and/or a tocopherol are used.

12. The method according to claim 1, wherein (ii) is tocopherol and rosmarinic acid.

13. The method according to claim 1, wherein (ii) is cyclodextrin and rosmarinic acid.

14. The method according to claim 1, wherein rosmarinic acid is obtained from a Lamiaceae.

15. The method according to claim 1, wherein additionally chlorogenic acid is used, and wherein the chlorogenic acid is obtained from green beans from any species of the genus coffea.

16. A stabilized pigment obtained according to the method of claim 1.

17. A stabilized Polyketide pigment comprising (i) a Polyketide pigment according to claim 1 and one or more of (ii) a carotenoid, rosmarinic acid, a chlorogenic acid, rutin glucoside, (gamma) cyclodextrin and/or a tocopherol.

18. The stabilized pigment according to claim 16, characterized by having a colour that is stable to light exposure.

19. A colouring composition comprising a stabilized pigment according to claim 16.

20. A foodstuff, a pharmaceutical, a nutraceutical, a perfume or a cosmetic product comprising a stabilized pigment according to claim 16, optionally that was exposed to light.

21. A method for producing a foodstuff, a pharmaceutical, a nutraceutical, a perfume or a cosmetic product comprising the steps of incorporating a stabilized pigment according to claim 16 in a foodstuff, a pharmaceutical, a nutraceutical, a perfume or a cosmetic product.

22. A method for producing a foodstuff, a pharmaceutical, a nutraceutical, a perfume or a cosmetic product comprising the steps of incorporating components (i) and component (ii) as defined in claim 1, wherein component (i) is added directly to the product and consequently product (ii) is also added to the product or wherein component (ii) is added directly to the product and consequently product (i) is also added to the product.

23. A foodstuff, a pharmaceutical, a nutraceutical, a perfume or a cosmetic product obtained using the method of claim 21, characterized by having a red, orange or yellow colour that is stable to light.
